(19) United States
(12) Patent Application Publication
(10) Pub. No.: US 2013/0176005 A1
(43) Pub. Date: Jul. 11, 2013

(54) DC/DC CONVERTER AND CONTROL METHOD THEREOF

(71) Applicants: Hong-Yuan JIN, Shanghai (CN); Pei-Qing HU, Shanghai (CN); Hong-Jian GAN, Shanghai (CN); Jian-Ping YING, Shanghai (CN)

(72) Inventors: Hong-Yuan JIN, Shanghai (CN); Pei-Qing HU, Shanghai (CN); Hong-Jian GAN, Shanghai (CN); Jian-Ping YING, Shanghai (CN)

(73) Assignee: DELTA ELECTRONICS (SHANGHAI) CO., LTD., Shanghai (CN)

(21) Appl. No.: 13/481,058

(22) Filed: May 25, 2012

(30) Foreign Application Priority Data
Jan. 10, 2012 (CN) 201210006225.9

(51) Int. Cl. G05F 1/46

(52) U.S. Cl. 323/234

(57) ABSTRACT

The DC/DC converter includes a power unit, an output detection unit, a control unit and a compensation unit. The output detection unit detects an output stage of the power unit. The control unit provides a driving signal based on the output stage for the power unit to control the operation of the power unit. When the power unit operates in an intermittent working mode, the compensation unit provides a compensation signal for the control unit, and the control unit adjusts the driving signal according to the compensation signal, so that during at least one duty cycle an output power of the power unit in the intermittent working mode is higher than an output power of the power unit at a switching moment from a normal mode (continuous working mode) to the intermittent working mode, thereby when the load is not changed, the average number of driving signals is reduced.

### RELATED APPLICATIONS

This application claims priority to Chinese Application Serial Number 201210006225.9, filed Jan. 10, 2012, which is herein incorporated by reference.

### BACKGROUND

1. Technical Field

The present disclosure relates to power electronic, and more particularly, a DC/DC converter and a control method thereof.

2. Description of Related Art

In recent years, with the fast development of the energy conservation technology, more and more customers desire that a switching-mode converter can achieve high conversion efficiency in a wide load range, so improving the efficiency of this converter in a light-load or a no-load is also very important. In this regard, the International Energy Agency (IEA), the United States and Europe and other countries and organizations have been established or are establishing standards to limit a loss of the switching-mode converter in the light-load and the no-load.

The feedback is introduced into the actual DC-DC converter to adjust the power level output by detecting the output state, to stabilize the output of the converter output stability and to simple circuitry, and thus favored by many people.

FIG. 1 is a block diagram of a conventional DC/DC converter. This DC-DC converter consists of four parts: a power unit 1, an output detection unit 2, a controller 4 and a driving unit 5, where the controller 4 and the driving unit 5 constitute a control unit 3. The output detection unit 2 detects output state of the converter, and the control unit 3 generates a driving signal to control the operation of the power unit 1, so as to constitute a feedback loop to achieve a closed-loop control of the converter, the output can get very high accuracy and high stability.

In traditional control methods, the change of the feedback signal simply depends on the load change. When a light-load or no-load, the feedback signal causes the converter to transmit very small energy in each work cycle. Due to drive loss and switching loss, the conversion efficiency of the converter is very low. Furthermore, due to the lag due to the regulator, the output voltage is dropped adversely when the output load is abruptly increased. The traditional method is to improve the efficiency in the light load and no-load by operating in an intermittent working mode.

As shown in FIG. 2, when the load is decreased, the feedback signal is also decreased. When the feedback signal is decreased to be VL, decreasing the feedback signal is stopped. If the feedback signal is less than VL, the converter will shut down. If the feedback signal is higher than VL, the converter will operate anew. In each cycle, transmission of energy still depends on the feedback signal, and therefore the converter operates in the intermittent working mode. In this way, the on-off times and overall losses are reduced per unit time. Since the value of the feedback signal is still around entering the intermittent working mode, during the standby the output energy is still small in each cycle. Therefore, the duty cycle is more, the light-load losses or no-load losses are higher. Furthermore, if the output load suddenly becomes larger, the output voltage will be dropped due to the impact of the regulator in the feedback loop.

In view of the foregoing, there is one of the urgent needs in the related field to provide a way to reduce the light-load losses and no-load losses and to solve the drop of the output voltage when the output load suddenly becomes larger.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one or more various aspects, the present disclosure is directed to a DC/DC converter and a method of controlling the DC/DC converter to meet the requirements for reducing the light-load losses and no-load losses and for solving the drop of the output voltage when the output load suddenly becomes larger.

According to one embodiment of the present invention, a DC/DC converter includes a power unit, an output detection unit, a control unit and a compensation unit. The output detection unit detects an output stage of the power unit. The control unit provides a driving signal based on the output stage for the power unit to control the operation of the power unit. When the power unit operates in an intermittent working mode, the compensation unit provides a compensation signal for the control unit, and the control unit adjusts the driving signal according to the compensation signal, so that during at least one duty cycle an output power of the power unit in the intermittent working mode is higher than an output power of the power unit at a switching moment from a normal mode (continuous working mode) to the intermittent working mode, thereby when the load is not changed, the average number of driving signals is reduced.

In addition, the output power of the power unit in the intermittent working mode is higher than the output power of the power unit at a switching moment from a normal mode (continuous working mode) to the intermittent working mode.

The control unit includes a driver and a controller. The driver is electrically coupled with the power unit. The controller controls the driver so that the driver generates the driving signal.

The compensation unit sends the compensation signal to the driver, and the driver adjusts the driving signal according to the compensation signal.

Alternatively, the compensation unit sends the compensation signal to the controller, and the controller commands the driver to adjust the driving signal according to the compensation signal.

The controller includes a first controller, a second controller and a regulator. The first controller is electrically coupled with the driver. The second controller is electrically coupled with the first controller. The regulator receives an output signal from the output detection unit and sends a modulation signal to the first and second controllers according to the output signal, wherein the compensation unit sends the compensation signal to the second controller, and then the second controller sends a control signal to the first controller, so that the first controller sends another control signal of the intermittent working mode to the driver, whereby the driver adjusts the driving signal.

Alternatively, the controller includes an and gate circuit, a first controller, a second controller and a regulator. The and gate circuit is electrically coupled with the driver. The first controller is electrically coupled with the and gate circuit. The second controller is electrically coupled with the and gate circuit. The regulator receives an output signal from the output detection unit and sends a modulation signal to the first and second controllers according to the output signal, wherein the first controller generates a first control signal based on the modulation signal, the compensation unit sends the compensation signal to the second controller, and the second controller sends a second control signal based on the modulation signal to the and gate circuit, so that when the first control signal conforms to the second control signal, the and gate circuit sends the first control signal of the intermittent working mode to the driver, whereby the driver adjusts the driving signal.

In addition, the second controller includes a comparator for comparing a reference voltage with the modulation signal so as to output the second control signal.

The compensation signal generated by the compensation unit is used to compensate for the reference voltage or the modulation signal.

When a value of the modulation signal is lower than a first predetermined value, the power unit operates in the intermittent working mode, and the reference voltage is increased to be a second predetermined value by the modulation signal so that when the value of the modulation signal is lower than the second predetermined value, the power unit shuts down; when the value of the modulation signal is higher than the second predetermined value, the power unit operates anew, wherein the second predetermined value is greater than the first predetermined value.

When the output detection unit determines that the output stage is changed from a light-load or a no-load to a heavy-load, the compensation unit stops compensating for the reference voltage, and the power unit operates in the normal mode.

According to another embodiment of the present invention, a method of controlling the DC/DC converter includes following steps: (a) detecting an output stage of a power unit; (b) providing a driving signal based on the output stage for the power unit, so as to control operation of the power unit; (c) providing a compensation signal for the control unit when the power unit operates in an intermittent working mode; and (d) adjusting the driving signal according to the compensation signal so that during at least one duty cycle an output power of the power unit in the intermittent working mode is higher than an output power of the power unit at a switching moment from a normal mode (continuous working mode) to the intermittent working mode, thereby reducing the average number of driving signals when the load is not changed.

In addition, the output power of the power unit in the intermittent working mode is higher than the output power of the power unit at a switching moment from a normal mode (continuous working mode) to the intermittent working mode.

The DC/DC converter includes a driver, and the step (d) comprises: controlling the driver so that the driver generates the driving signal.

The step (c) includes: sending the compensation signal to the driver, and the step (d) further includes: adjusting the driving signal by the driver according to the compensation signal.

Alternatively, the step (d) further includes: commanding the driver to adjust the driving signal according to the compensation signal.

The DC/DC converter further includes a first controller electrically coupled with the driver, and a second controller electrically coupled with the first controller. The method further includes: sending a modulation signal to the first and second controllers according to the output stage, wherein the compensation signal in the step (c) is sent to the second controller, and then the second controller sends a control signal to the first controller, so that the first controller sends another control signal of the intermittent working mode to the driver, whereby the driver adjusts the driving signal.

Alternatively, the DC/DC converter further comprises an and gate circuit electrically coupled with the driver, a first controller electrically coupled with the and gate circuit, and a second controller electrically coupled with the and gate circuit. The method further includes: sending a modulation signal to the first and second controllers according to the output stage, wherein the first controller generates a first control signal based on the modulation signal, the compensation signal in the step (c) is sent to the second controller, and the second controller sends a second control signal based on the modulation signal to the and gate circuit, so that when the first control signal conforms to the second control signal, the and gate circuit sends the first control signal of the intermittent working mode to the driver, whereby the driver adjusts the driving signal.

The second controller includes a comparator for comparing a reference voltage with the modulation signal so as to output the second control signal.

The step (c) includes: generating the compensation signal to compensate for the reference voltage or the modulation signal.

The step (c) further includes: when a value of the modulation signal is lower than a first predetermined value, the power unit operates in the intermittent working mode, utilizing the modulation signal to increase the reference voltage to be a second predetermined value, so that when the value of the modulation signal is lower than the second predetermined value, the power unit shuts down; when the value of the modulation signal is higher than the second predetermined value, the power unit operates anew, wherein the second predetermined value is greater than the first predetermined value.

The step (c) further includes: when the output stage is changed from a light-load or a no-load to a heavy-load as determined in the step (a), stopping compensating for the reference voltage, so that the power unit operates in the normal mode.

One of the technical advantages is generally achieved, by embodiments of the present invention, as follows: by adding compensation, when the power unit operates in an intermittent working mode, during at least one duty cycle an output power of the power unit in the intermittent working mode is higher than an output power of the power unit at a switching moment from a normal mode (continuous working mode) to the intermittent working mode, thereby when the load is not changed, the average number of driving signals is reduced. When the power unit operates in the light-load and no-load, the on-off times of the converter switch per unit time is reduced more efficiently. Therefore, the efficiency in the light-load and no-load is improved, and the drop of the output voltage is solved when the output load suddenly becomes larger.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram of a conventional DC/DC converter;

FIG. 2 illustrates a feedback signal based on a conventional method of controlling the DC/DC converter of FIG. 1;

FIG. 3 illustrates a method of controlling the DC/DC converter according to one embodiment of the present disclosure;

FIG. 4 is a block diagram of a DC/DC converter according to one embodiment of the present disclosure;

FIG. 5 is a flowchart of controlling the DC/DC converter of FIG. 4;

FIG. 6 is a block diagram of illustrating a control unit according to an embodiment of the present disclosure;

FIG. 7 is a block diagram of illustrating a control unit according to an embodiment of the present disclosure;

FIG. 8 is a block diagram of illustrating controllers of the control unit according to an embodiment of the present disclosure;

FIG. 9 is a block diagram of illustrating controllers of the control unit according to an embodiment of the present disclosure;

FIG. 10 is a block diagram of illustrating the controller of FIG. 9 according to an embodiment of the present disclosure;

FIG. 11 illustrates a modulation signal based on a novel method of controlling the DC/DC converter according to one embodiment of the present disclosure;

FIG. 12 is a flowchart of entering an intermittent working mode according to one embodiment of the present disclosure; and

FIG. 13 is a flowchart of exiting an intermittent working mode according to one embodiment of the present disclosure.

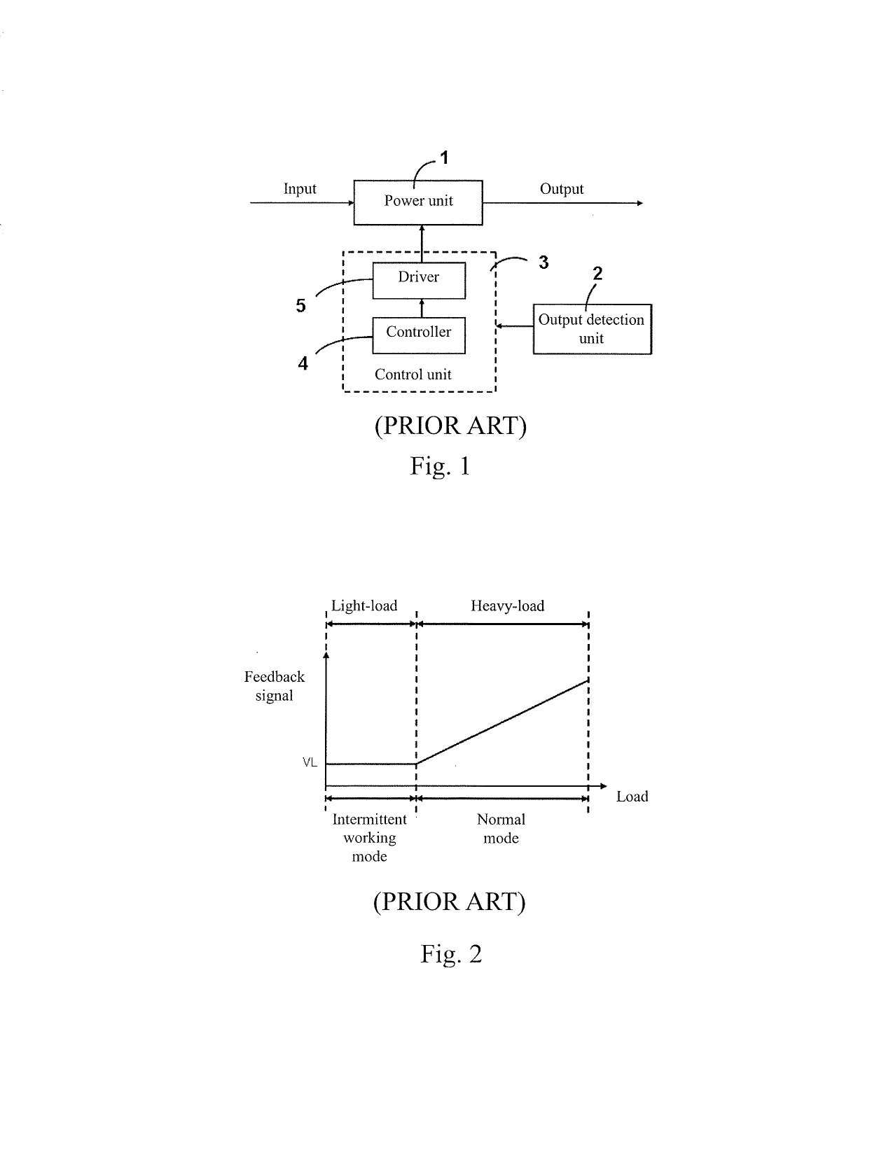

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

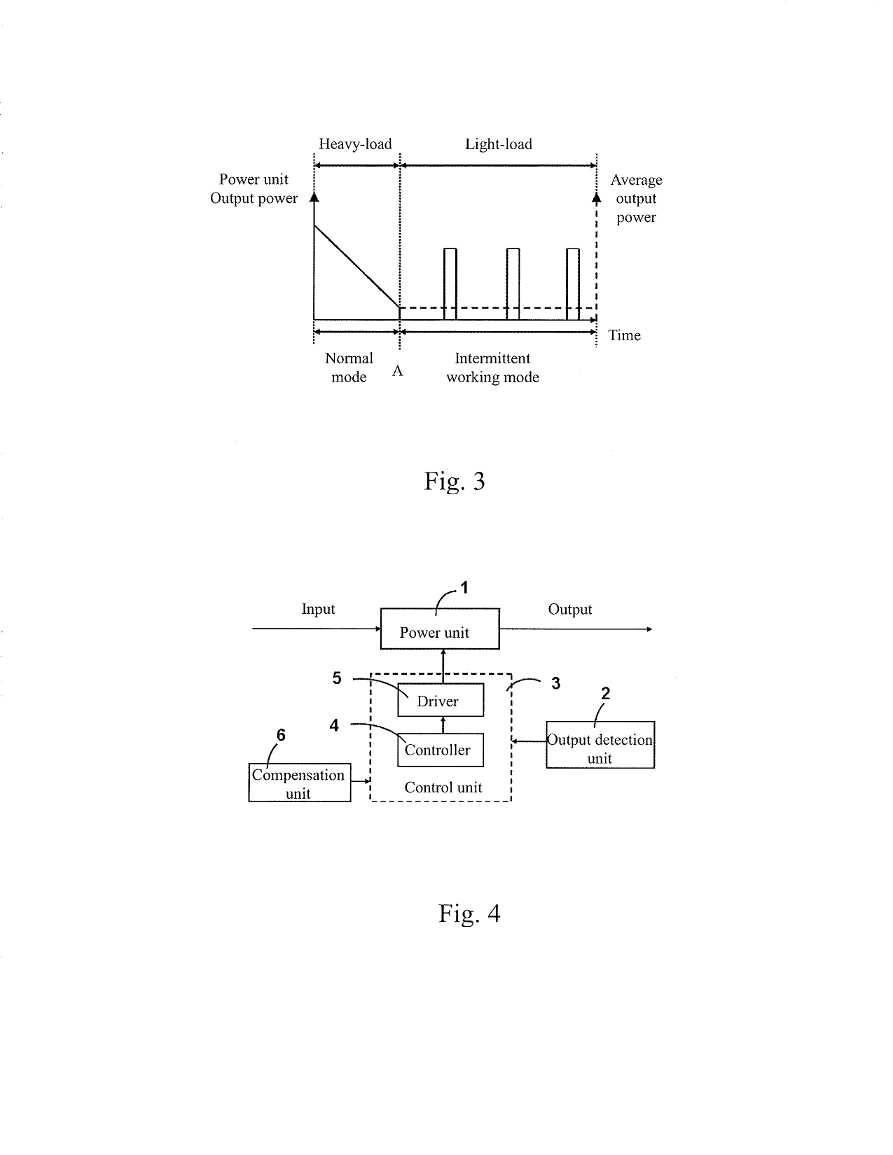

In one or more various aspects, the present disclosure is directed to meet the requirements for high efficiency in the light-load and no-load, and to solve the drop of the output voltage when the output load suddenly becomes larger. The main control method of the present disclosure is to add compensation in a control unit. In this way, when the power unit operates in an intermittent working mode, during at least one duty cycle an output power of the power unit in the intermittent working mode is higher than an output power of the power unit at a switching moment from a normal mode (continuous working mode) to the intermittent working mode, thereby when the load is not changed, the average number of driving signals is reduced. On the other hand, the output power of the power unit in the intermittent working mode will be higher than the output power of the power unit at the switching moment from the normal mode (continuous working mode) to the intermittent working mode only during one or more duty cycles without during each and every duty cycle if the decrease of the average number of driving signals is achieved when the load is not changed. In one embodiment, the output power of the power unit in the intermittent working mode is higher than the output power of the power unit at the switching moment from the normal mode (continuous working mode) to the intermittent working mode. As shown in FIG. 3, when the power unit operates in the light-load and no-load, the on-off times of the converter switch per unit time is reduced because the converter can transmit more energy in each work cycle. Therefore, the efficiency in the light-load and no-load is improved.

Referring to FIG. 4, illustrated is a block diagram of a DC/DC converter according to one embodiment of the present disclosure. This converter may be easily inserted into a power converter, and may be applicable or readily adaptable to all related technology.

In FIG. 4, the DC/DC converter includes a power unit 1, an output detection unit 2, a control unit 3 and a compensation unit 6. The control unit 3 electrically coupled with the power unit 1, the output detection unit 2 is electrically coupled with the control unit 3, and the compensation unit 6 is electrically coupled with the control unit 3. The output detection unit 2 detects an output stage of the power unit 1. The control unit 3 provides a driving signal based on the output stage for the power unit 1 to control the operation of the power unit 1. When the power unit 1 operates in an intermittent working mode, the compensation unit 6 provides a compensation signal for the control unit 3, and the control unit 3 adjusts the driving signal according to the compensation signal, so that during at least one duty cycle an output power of the power unit 1 in the intermittent working mode is higher than an output power of the power unit 1 at a switching moment from a normal mode (continuous working mode) to the intermittent working mode, thereby when the load is not changed, the average number of driving signals is reduced. In one embodiment, the output power of the power unit 1 in the intermittent working mode is higher than the output power of the power unit 1 at the switching moment (e.g., the point A shown in FIG. 3) from the normal mode (continuous working mode) to the intermittent working mode.

It should be noted that when the converter works in the intermittent working mode, the compensation unit 6 generates the compensation signal, and the control unit 3 drives the power unit 1 so that output power of the power unit 1 in the intermittent working mode is higher than an output power of the power unit 1 at a switching moment from a normal mode (continuous working mode) to the intermittent working mode.

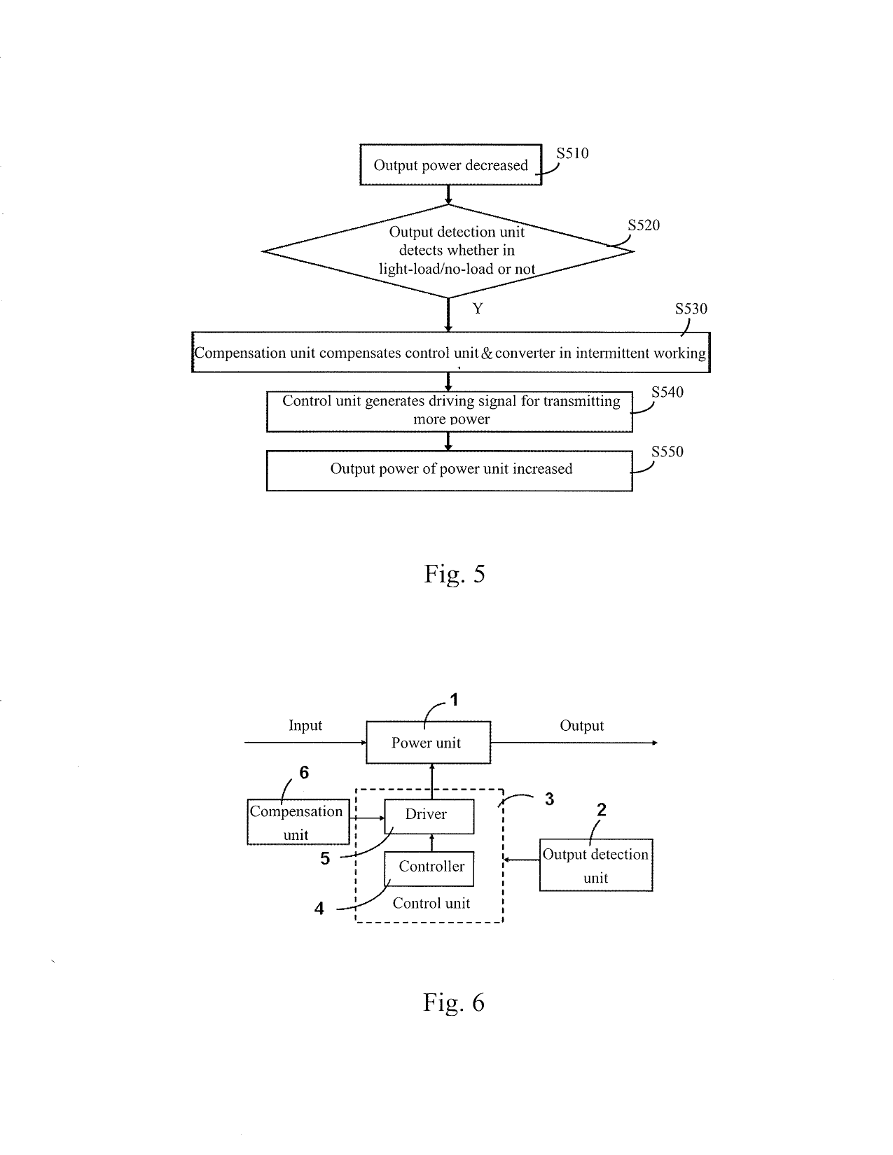

Referring to FIG. 5, illustrated is a flowchart of controlling the DC/DC converter. In step S510, the output power is decreased. In step S520, when it is determined that the output detection unit 2 detects that the output power is less than a predetermined value, the converter works in the intermittent working mode. In steps S510-S550, the compensation unit 6 generates the compensation signal, and the control unit 3 generates the driving signal for the power unit 1 so that during at least one duty cycle, the output power of the power unit 1 in the intermittent working mode is higher than an output power of the power unit 1 at a switching moment from a normal mode (continuous working mode) to the intermittent working mode, thereby when the load is not changed, the average number of driving signals is reduced. In one embodiment, the output power of the power unit 1 in the intermittent working mode is higher than the output power of the power unit 1 at the switching moment from the normal mode (continuous working mode) to the intermittent working mode.

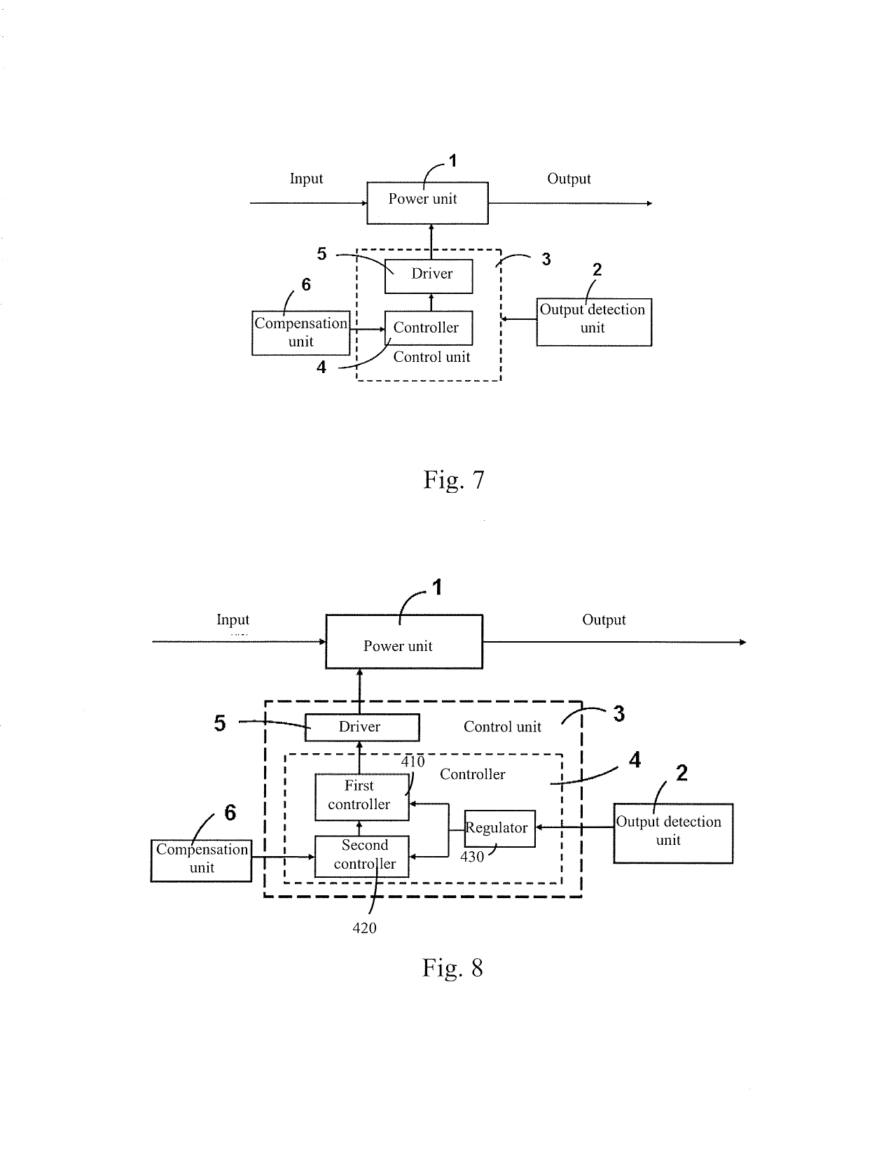

The control unit 3 includes a driver 5 and a controller 4. The driver 5 is electrically coupled with the power unit 1, and the controller 4 is electrically coupled with the driver 5. In use, the controller 4 controls the driver 5 so that the driver 5 generates the driving signal. The compensation unit 6 sends the compensation signal to the driver 5 of the control unit 3, as shown in FIG. 6, and the driver 5 adjusts the driving signal according to the compensation signal. Alternatively, the compensation unit 6 sends the compensation signal to the controller 4 of the control unit 3, as shown in FIG. 7, and the controller 4 commands the driver 5 to adjust the driving signal according to the compensation signal.

When the compensation unit 6 sends the compensation signal to the driver 5 of the control unit 3, the driving signal generated by the driver 5 is changed by the compensation signal, so that during at least one duty cycle, the output power of the power unit 1 in the intermittent working mode is higher than an output power of the power unit 1 at a switching moment from a normal mode (continuous working mode) to the intermittent working mode, thereby when the load is not changed, the average number of driving signals is reduced. In one embodiment, the output power of the power unit 1 in the intermittent working mode is higher than the output power of the power unit 1 at the switching moment from the normal mode (continuous working mode) to the intermittent working mode. For example, the duty ratio of the driving signal can be changed for a fly-back circuit, a forward circuit, or an asymmetric half-bridge circuit, in which the output of these circuits is stabilized by a fixed-frequency and the change of the duty ratio; alternatively, the frequency of the driving signal can be changed for a resonant circuit, such as LLC series resonant circuit, in which the output of the resonant circuit is stabilized by a fixed duty ratio and the change of the frequency; additionally or alternatively, the duty ratio and the frequency of the driving signal can be changed for a critical discontinuous mode fly-back circuit, a boost circuit or the like.

When the compensation unit 6 sends the compensation signal to the controller 4 of the control unit 3, the driving signal generated by the controller 4 is changed by the compensation signal, so that during at least one duty cycle, the output power of the power unit 1 in the intermittent working mode is higher than an output power of the power unit 1 at a switching moment from a normal mode (continuous working mode) to the intermittent working mode, thereby when the load is not changed, the average number of driving signals is reduced. In one embodiment, the output power of the power unit 1 in the intermittent working mode is higher than the output power of the power unit 1 at the switching moment from the normal mode (continuous working mode) to the intermittent working mode.

As illustrated in FIG. 8, the controller 4 includes a first controller 410, a second controller 420 and a regulator 430. The regulator 430 is electrically coupled with the first controller 410 and the second controller 420, the first controller 410 is electrically coupled with the driver 5, and the second controller 420 is electrically coupled with the first controller 410. The output detection unit 2 sends an output signal to the regulator 430 of the controller 4, and the regulator 430 receives the output signal from the output detection unit 2. The regulator 430 generates a modulation signal according to the output signal and sends the modulation signal to the first controller 410 for the normal mode and the second controllers 420 for the intermittent working mode. The second controller 420 sends a control signal to the first controller 410, and the compensation signal generated by the compensation unit 6 can compensate for the second controller 420 of the controller 4, to affect another control signal of the first controller 410, so that the first controller can send the control signal of the intermittent working mode to the driver 5. Accordingly, the driver 5 adjusts the driving signal so that during at least one duty cycle, the output power of the power unit 1 in the intermittent working mode is higher than an output power of the power unit 1 at a switching moment from a normal mode (continuous working mode) to the intermittent working mode, thereby when the load is not changed, the average number of driving signals is reduced. In one embodiment, the output power of the power unit 1 in the intermittent working mode is higher than the output power of the power unit 1 at the switching moment from the normal mode (continuous working mode) to the intermittent working mode.

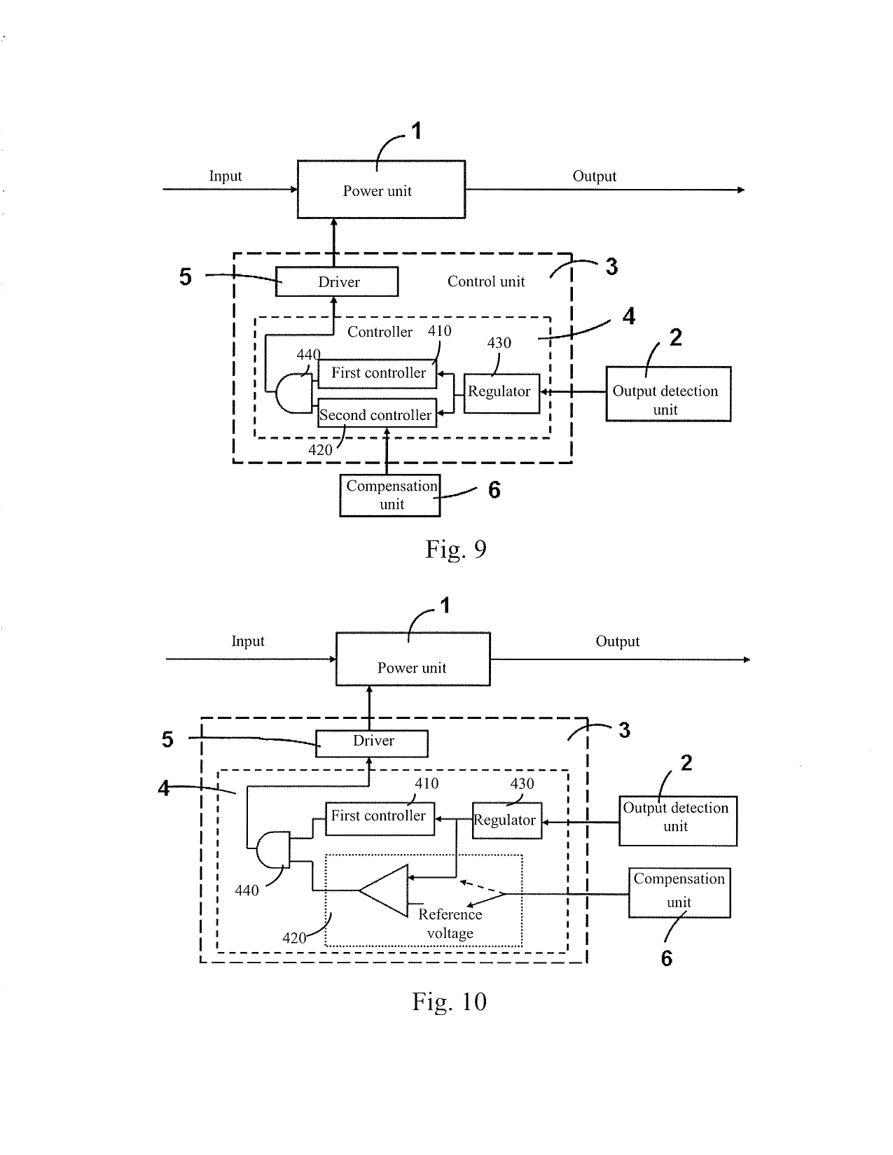

As illustrated in FIG. 9, the controller 4 includes a first controller 410, a second controller 420, a regulator 430 and an and gate circuit 440. The and gate circuit 440 is electrically coupled with the driver 5, the first controller 410 is electrically coupled with the and gate circuit 440, the second controller 420 is electrically coupled with the and gate circuit 440, and the regulator 430 is electrically coupled with the first and second controllers 410 and 420. The output detection unit 2 sends an output signal to the regulator 430 of the controller 4, and the regulator 430 receives the output signal from the output detection unit 2. The regulator 430 generates a modulation signal according to the output signal and sends the modulation signal to the first controller 410 for the normal mode and the second controllers 420 for the intermittent working mode. A second control signal of the second controllers 420 can control whether a first control signal of the first controller 410 is transmitted to the driver 5 by means of the and gate circuit 440. When the first control signal conforms to the second control signal, the and gate circuit 440 sends the first control signal of the intermittent working mode to the driver 5, whereby the driver 5 adjusts the driving signal. The compensation signal generated by the compensation unit 6 can compensate for the second controller 420 of the controller 4, to affect the first control signal of the first controller 410, so that during at least one duty cycle, the output power of the power unit 1 in the intermittent working mode is higher than an output power of the power unit 1 at a switching moment from a normal mode (continuous working mode) to the intermittent working mode, thereby when the load is not changed, the average number of driving signals is reduced. In one embodiment, the output power of the power unit 1 in the intermittent working mode is higher than the output power of the power unit 1 at the switching moment from the normal mode (continuous working mode) to the intermittent working mode.

Furthermore, referring to FIG. 10, illustrated is a block diagram of illustrating the second controller 420 of FIG. 9. The second controller 420 includes a comparator. With the decrease of the output load, the modulation signal generated by the regulator 430 is decreased for reducing the transmission power of the power unit 1. When the decreased modulation signal is less than the reference voltage of the second controller 420, the first controller 410 shuts down according to the control signal based on the modulation signal, so that the driver 5 cannot generate the driving signal. Therefore, the converter operates in the intermittent working mode. At this time, the compensation signal generated by the compensation unit 6 is used to compensate for the reference voltage or the modulation signal. By modulation signal generated from the regulator 430, during at least one duty cycle, the output power of the power unit 1 in the intermittent working mode is higher than an output power of the power unit 1 at a switching moment from a normal mode (continuous working mode) to the intermittent working mode, thereby when the load is not changed, the average number of driving signals is reduced. In one embodiment, the output power of the power unit 1 in the intermittent working mode is higher than the output power of the power unit 1 at the switching moment from the normal mode (continuous working mode) to the intermittent working mode, thereby improving the efficiency in the light-load or no-load.

Another advantage is achieved, by embodiments of the present invention, as follows. The compensation unit 6 in the intermittent working mode generates the compensation signal. Accordingly, by the modulation signal generated from the regulator 430, during at least one duty cycle, the output power of the power unit 1 in the intermittent working mode is higher than an output power of the power unit 1 at a switching moment from a normal mode (continuous working mode) to the intermittent working mode. In this way, when the output load suddenly becomes larger, the modulation signal of the regulator 430 is changed from a work point in the intermittent working mode to another work point in the heavy-mode, during which the time duration can be reduced efficiently. Thus, the drop of the output voltage can be decreased or even eliminated when the output load of the converter suddenly becomes larger in the light-load or no-load.

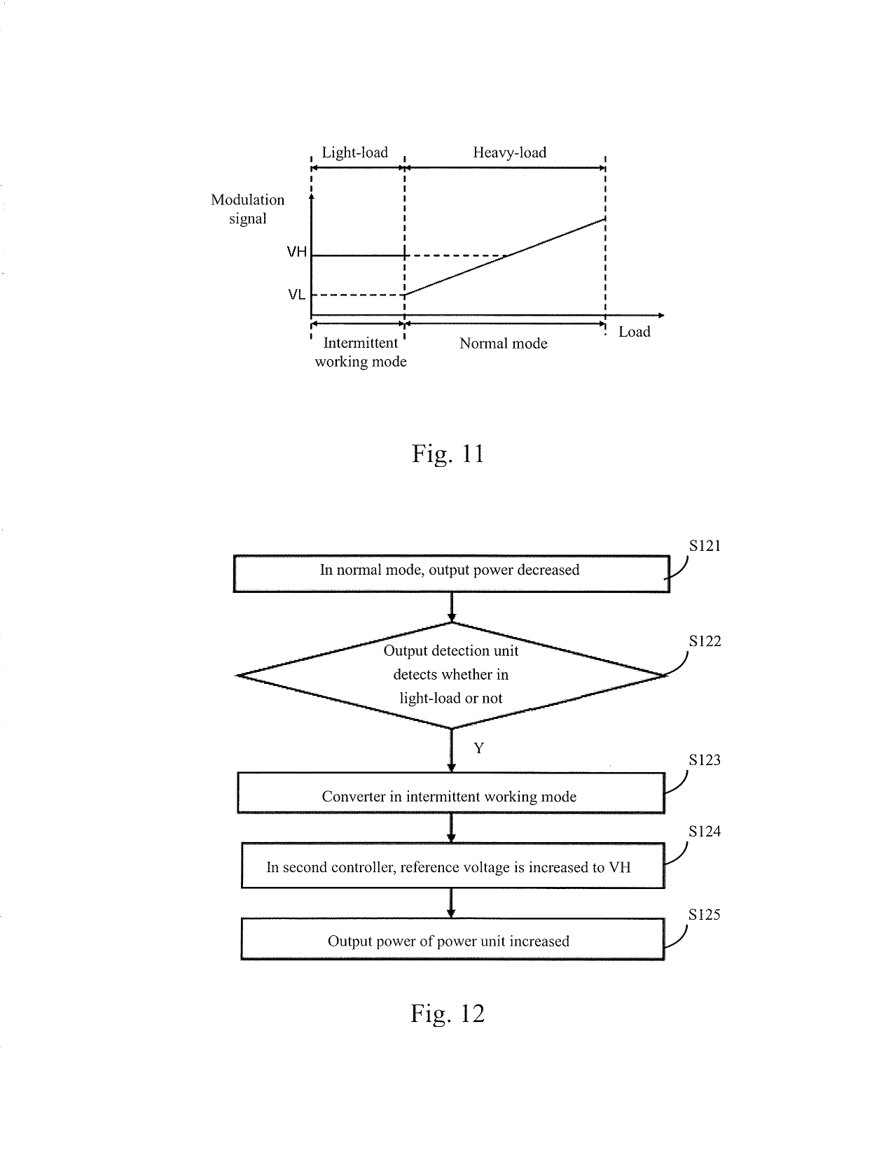

For example, the compensation signal generated by the compensation unit 6 is used to compensate for the reference voltage of the second controller 420. The regulator circuit increases the modulation signal when the output load is increased, as shown in FIG. 11. With the decrease of the load, a value of the modulation signal is decreased. When the value of the modulation signal is lower than a first predetermined value VL, the power unit operates in the intermittent working mode, and the reference voltage is increased to be a second predetermined value VH by the modulation signal. It should be noted that the first predetermined value VL and the second predetermined value VH are not constant values, and depend on the desired application.

When the value of the modulation signal is lower than the second predetermined value VH, the power unit shuts down; when the value of the modulation signal is higher than the second predetermined value VH, the power unit operates anew. When the modulation signal is set around the second predetermined value VH, during each cycle, the transmission energy in the intermittent working mode is approximately equal to the transmission energy in the normal mode and is higher than the transmission energy at the first predetermined value VL. Above routine is shown in steps S121-S125 of FIG. 12.

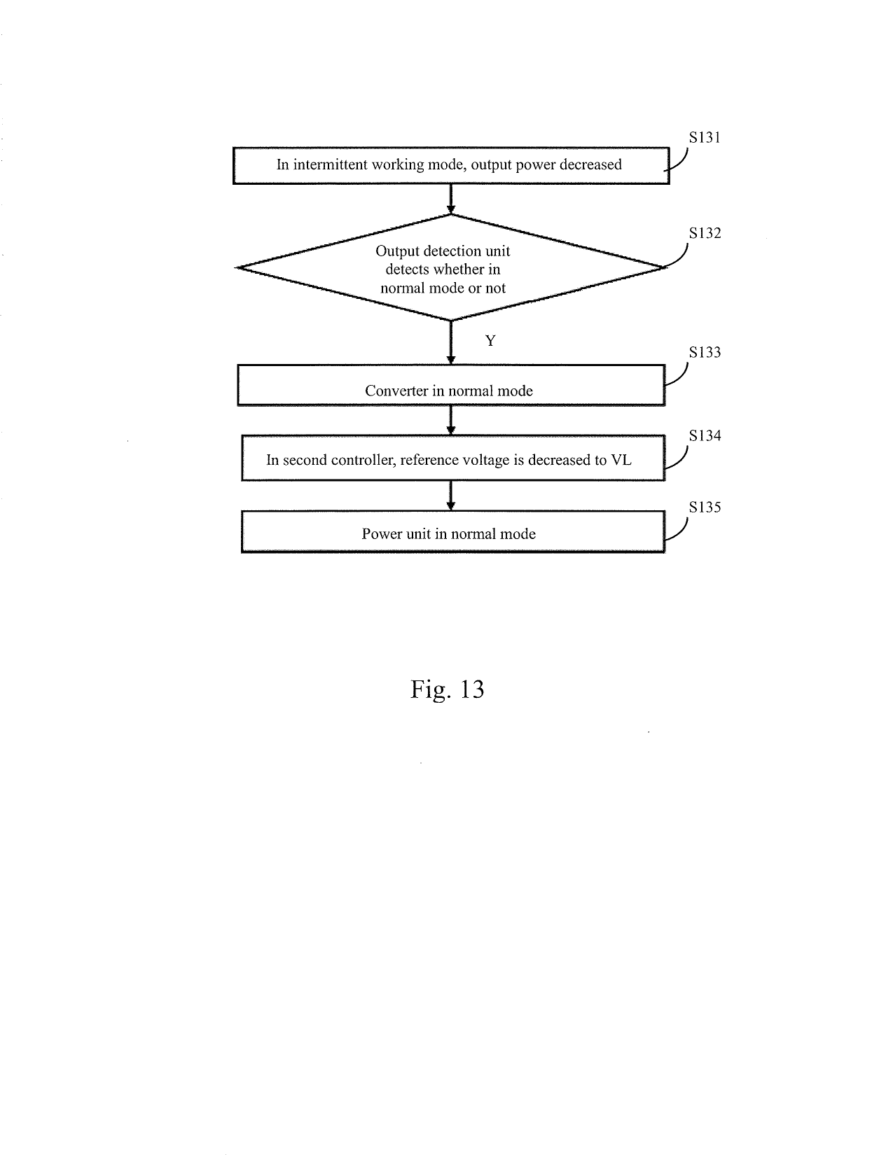

The state of the load is detected. When the state of the load is changed from the light-load to the heavy-load, i.e. from the intermittent working mode to the normal mode, the compensation for the reference voltage is cancelled, and the converter operates in the normal mode. Because the value of the modulation signal is set around the second predetermined value VH, when the state of load in the light-load is suddenly increased, a time duration of changing the modulation signal from VH to a stationary point is less than another time duration of changing the modulation signal from VL to a stationary point. Thus, the drop of the output voltage can be decreased or even eliminated when the output load of the converter suddenly becomes larger in the light-load or no-load. Above routine is shown in steps S131-S135 of FIG. 13.

For example, above converter may be a LLC series resonant circuit, in which the working frequency is lower when the load is larger, and the working frequency is higher when the work the load is lesser. The modulation signal generated by the regulator depends on the working frequency of the converter, in which when the load is larger, the feedback signal is larger and the working frequency is lower; when the work the load is lesser, the feedback signal is lesser and the working frequency is higher. In the intermittent working mode, the converter shuts down when the value of the modulation signal is lower than the reference voltage of the second controller 420; the converter works anew when the value of the modulation signal is greater than the reference voltage of the second controller 420. Specifically, the output power of the converter in the intermittent working mode is higher than the output power of the converter at a switching moment from the normal mode to the intermittent working mode, i.e. a working frequency in the intermittent working mode is lower than a working frequency at a switching moment from the normal mode to the intermittent working mode. When and after the converter works in the intermittent working mode, the reference voltage of the second controller 420 is increased. When the state of the load is changed from the light-load to the heavy-load, the operation of the converter changes from the intermittent working mode to the normal mode, and the reference voltage of the second controller 420 is decreased.

The output detection unit 2, a control unit 3 and a compensation unit 6 may be hardware, software, and/or firmware. For example, if speed and accuracy are specific concerns, the control unit 150 may opt for a mainly hardware and/or firmware; alternatively, if flexibility is specific concerns, the control unit 150 may opt for a mainly software implementation; or, yet again alternatively, the control unit 150 may opt for some combination of hardware, software, and/or firmware. Hence, there are several possible implementation way by which the processes and/or devices and/or other technologies described herein may be effected, none of which is inherently superior to the other in that any implementation way to be utilized is a choice dependent upon the context in which the implementation way will be deployed and the specific concerns (e.g., speed, flexibility, or predictability), any of which may vary.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. A DC/DC converter comprising:
a power unit;
an output detection unit for detecting an output stage of the power unit;
a control unit for providing a driving signal based on the output stage for the power unit, so as to control operation of the power unit;
a compensation unit for providing a compensation signal for the control unit when the power unit operates in an intermittent working mode, the control unit for adjusting the driving signal according to the compensation signal so that during at least one duty cycle an output power of the power unit in the intermittent working mode is higher than an output power of the power unit at a switching moment from a normal mode (continuous working mode) to the intermittent working mode, thereby reducing the average number of driving signals when the load is not changed.

2. The DC/DC converter of claim 1, wherein the output power of the power unit in the intermittent working mode is higher than the output power of the power unit at a switching moment from a normal mode (continuous working mode) to the intermittent working mode.

3. The DC/DC converter of claim 1, wherein the control unit comprising:
a driver electrically coupled with the power unit;
a controller for controlling the driver so that the driver generates the driving signal.

4. The DC/DC converter of claim 3, wherein the compensation unit sends the compensation signal to the driver, and the driver adjusts the driving signal according to the compensation signal.

5. The DC/DC converter of claim 3, wherein the compensation unit sends the compensation signal to the controller, and the controller commands the driver to adjust the driving signal according to the compensation signal.

6. The DC/DC converter of claim 5, wherein the controller comprising:
a first controller electrically coupled with the driver;
a second controller electrically coupled with the first controller; and
a regulator for receiving an output signal from the output detection unit and for sending a modulation signal to the first and second controllers according to the output signal, wherein the compensation unit sends the compensation signal to the second controller, and then the second controller sends a control signal to the first controller, so that the first controller sends another control signal of the intermittent working mode to the driver, whereby the driver adjusts the driving signal.

7. The DC/DC converter of claim 5, wherein the controller comprising:
an and gate circuit electrically coupled with the driver;
a first controller electrically coupled with the and gate circuit;
a second controller electrically coupled with the and gate circuit; and
a regulator for receiving an output signal from the output detection unit and for sending a modulation signal to the first and second controllers according to the output signal, wherein the first controller generates a first control signal based on the modulation signal, the compensation unit sends the compensation signal to the second controller, and the second controller sends a second control signal based on the modulation signal to the and gate circuit, so that when the first control signal conforms to the second control signal, the and gate circuit sends the first control signal of the intermittent working mode to the driver, whereby the driver adjusts the driving signal.

8. The DC/DC converter of claim 7, wherein the second controller comprises a comparator for comparing a reference voltage with the modulation signal so as to output the second control signal.

9. The DC/DC converter of claim 1, wherein the compensation signal generated by the compensation unit is used to compensate for the reference voltage or the modulation signal.

10. The DC/DC converter of claim 9, wherein when a value of the modulation signal is lower than a first predetermined value, the power unit operates in the intermittent working mode, and the reference voltage is increased to be a second predetermined value by the compensation signal, so that when the value of the modulation signal is lower than the second predetermined value, the power unit shuts down; when the value of the modulation signal is higher than the second predetermined value, the power unit operates anew, wherein the second predetermined value is greater than the first predetermined value.

11. The DC/DC converter of claim 10, wherein when the output detection unit determines that the output stage is changed from a light-load or a no-load to a heavy-load, the compensation unit stops compensating for the reference voltage, and the power unit operates in the normal mode.

12. A method of controlling a DC/DC converter, the method comprising:
(a) detecting an output stage of a power unit;
(b) providing a driving signal based on the output stage for the power unit, so as to control operation of the power unit;
(c) providing a compensation signal for the control unit when the power unit operates in an intermittent working mode; and
(d) adjusting the driving signal according to the compensation signal so that during at least one duty cycle an output power of the power unit in the intermittent working mode is higher than an output power of the power unit at a switching moment from a normal mode (continuous working mode) to the intermittent working mode, thereby reducing the average number of driving signals when the load is not changed.

13. The method of claim 12, wherein the output power of the power unit in the intermittent working mode is higher than the output power of the power unit at a switching moment from a normal mode (continuous working mode) to the intermittent working mode.

14. The method of claim 12, wherein the DC/DC converter comprises a driver, and the step (d) comprises:
controlling the driver so that the driver generates the driving signal.

15. The method of claim 14, wherein the step (c) comprises: sending the compensation signal to the driver, and the step (d) further comprises: adjusting the driving signal by the driver according to the compensation signal.

16. The method of claim 14, wherein the step (d) further comprises: commanding the driver to adjust the driving signal according to the compensation signal.

17. The method of claim 14, wherein the DC/DC converter further comprises a first controller electrically coupled with the driver, and a second controller electrically coupled with the first controller, the method further comprising:
sending a modulation signal to the first and second controllers according to the output stage, wherein the compensation signal in the step (c) is sent to the second controller, and then the second controller sends a control signal to the first controller, so that the first controller sends another control signal of the intermittent working mode to the driver, whereby the driver adjusts the driving signal.

18. The method of claim 14, wherein the DC/DC converter further comprises an and gate circuit electrically coupled with the driver, a first controller electrically coupled with the and gate circuit, and a second controller electrically coupled with the and gate circuit, the method further comprising:
sending a modulation signal to the first and second controllers according to the output stage, wherein the first controller generates a first control signal based on the modulation signal, the compensation signal in the step (c) is sent to the second controller, and the second controller sends a second control signal based on the modulation signal to the and gate circuit, so that when the first control signal conforms to the second control signal, the and gate circuit sends the first control signal of the intermittent working mode to the driver, whereby the driver adjusts the driving signal.

19. The method of claim 18, wherein the second controller comprises a comparator for comparing a reference voltage with the modulation signal so as to output the second control signal.

20. The method of claim 19, wherein the step (c) comprises: generating the compensation signal to compensate for the reference voltage or the modulation signal.

21. The method of claim 20, wherein the step (c) further comprises:
when a value of the modulation signal is lower than a first predetermined value, the power unit operates in the intermittent working mode, utilizing the modulation signal to increase the reference voltage to be a second predetermined value, so that when the value of the modulation signal is lower than the second predetermined value, the power unit shuts down; when the value of the modulation signal is higher than the second predetermined value, the power unit operates anew, wherein the second predetermined value is greater than the first predetermined value.

22. The method of claim 21, wherein the step (c) further comprises:
when the output stage is changed from a light-load or a no-load to a heavy-load as determined in the step (a), stopping compensating for the to reference voltage, so that the power unit operates in the normal mode.
